(19) United States
(12) Patent Application Publication
(10) Pub. No.: US 2013/0066936 A1
(43) Pub. Date: Mar. 14, 2013

(54) Proximal Adaptive Collapsed Cloud Systems

(71) Applicants: Ram Krishnan, Vallejo, CA (US); Vidya Govindan, Vallejo, CA (US); Asif Qamar, Vallejo, CA (US)

(72) Inventors: Ram Krishnan, Vallejo, CA (US); Vidya Govindan, Vallejo, CA (US); Asif Qamar, Vallejo, CA (US)

(21) Appl. No.: 13/448,386

(22) Filed: Apr. 16, 2012

Related U.S. Application Data
(60) Provisional application No. 61/475,334, filed on Apr. 14, 2011.

(51) Int. Cl. G06F 15/16

(52) U.S. Cl. 709/201

(57) ABSTRACT

A collapsed cloud proximal to the user of a client device determines, stores, and provides access to content needed by the user or group of users. Content needed by the user is pushed into one or more access points that a client device is accessing or is expected to access. The client device accesses the content via local access to the access point(s) that it connects to, access relevant content from the local storage of the access point that it connects to as it moves.

The present application for patent claims priority to Provisional Application No. 61/475,334 entitled, “METHOD FOR PROXIMAL ADAPTIVE COLLAPSED CLOUD SYSTEMS ” filed Apr. 14, 2011, and assigned to the assignee hereof and hereby expressly incorporated by reference herein.

### FIELD OF THE INVENTION

This invention relates to enabling a local access for a client device to content at one or more access points where the access points for the client device and content stored at the access points can be predictively determined based on machine learning related to history and/or future knowledge of access information, mobility patterns and content preferences associated with a user or group of users.

### BACKGROUND OF THE INVENTION

Mobile client devices can access a wireless network by connecting to access points or base-stations or NodeBs or EvolvedNodeBs depending on the wireless technology being used. In some cases, the access can be provided by a wired connection to an access point, such as direct wired connection over a LAN instead of a WLAN to a WiFi router. Examples of client devices include mobile devices such as laptops or tablets or smartphones or UE (user equipment) nodes. Examples of wireless technologies include but are not limited to the technologies such as 802.11a/b/g/n or LTE or UMTS, CDMA2000, WiMAX, and recommended by standards bodies such as IEEE 802.11, 3GPP, 3GPP2, or the WiMAX forum. Alternative wireless technologies include Bluetooth or Zigbee or other short range technologies as well. However, the content needed by a user is typically accessed by connecting to a remote server on the internet through the wireless connection afforded by an access point, and the access point has the ability to connect to the remote server via a network. Many intermediate nodes may be accessed via the network to finally reach the remote server. IP packets can be lost or delivered with significant delays due to packet losses or congestion in the network.

### SUMMARY OF THE INVENTION

Various aspects and embodiments of the invention are described in further detail below.

If the content can be kept closer to the client device such as at the access points or base-stations that the device connects to, then this can avoid the possibility of packets getting delayed or lost on networks that provide accesses to remote servers that serve content to a user. For this purpose, a cloud server maintains information about user content preferences and access and mobility history associated with a user's client device, and can predictively determine future needs related to user content needs, and the future access points that the client device is likely to connect with, and expected times for such access. The cloud server can a remote server on the internet or a set of collapsed cloud servers associated with access points associated with user, or a combination of a remote server and collapsed cloud servers. Content needed by a user is pushed into these one or more access points that a client device is accessing or is expected to access. The access to the content is provided by a local access to the stored content on an access point that the device is connected with, instead of an access via the internet to a remote server. If the device associates with a new access point while accessing content, it can be redirected to the local storage of the new access point to continue accessing the rest of the content.

### BRIEF DESCRIPTION OF THE DRAWINGS

The features and nature of the present invention will become more apparent from the detailed description set forth below when taken in conjunction with the drawings in which like reference characters identify correspondingly throughout and wherein:

FIG. 1 is a diagram representing a network environment with content delivery and predictive analytics servers, access points, and client devices

FIG. 2 is a block diagram showing the configuration of an example access point, with local storage, computing, and networking capabilities.

FIG. 3 is a flowchart outlining an exemplary operation to predictively determine relevant content for a user based on distributed machine learning for one user across access points, or across users across access points to pre-position relevant content for a user at one or more access points.

FIG. 4 is a flowchart outlining an exemplary operation to preposition predicted relevant content for a user at a new access point based on mobility information associated with the user.

FIG. 5 is a flowchart outlining an exemplary operation to predict one or more future access points that a client device will connect to, and to subsequently preposition predicted relevant content for a user at such access points.

FIG. 6 is a flowchart outlining an exemplary operation for the collapsed cloud to provide an IP address to enable access via http-get operations to chunks of data from local storage on an access point, and to subsequently provide another IP address to enable access via http-get operations to remaining chunks of data from local storage on a new access point.

### DETAILED DESCRIPTION OF THE INVENTION

Various aspects and embodiments of the invention are described in further detail below.

Proximal adaptive collapsed Cloud systems (PACCS) are presented. A PACCS server is available as a collapsed cloud service associated with an access point that provides access to client devices. A PACCS server has the ability to determine relevant for users of client devices associated with the access point. It can fetch relevant content from a content delivery server in the Internet Cloud. A PACCS server can be connected to the Internet Cloud through wired/wireless links. The wireless link can be a short-range link (BT/UWB), medium-range link (Wi-Fi) or a long-range link (LTE/WiMAX). Examples of a wired link can be an Ethernet cable. The PACCS server presents such derived information to PACCS clients that connect to it. PACCS clients that are within wired or wireless proximity of the PACCS server are able to utilize the PACCS services provided the PACCS server. A PACCS service advertised by a PACCS server can be discovered over a wired or wireless link by a PACCS client within wireless proximity of the PACCS server. The wireless link can be a short-range link (BT/UWB), medium-range link (Wi-Fi) or a long-range link (LTE/WiMAX). Examples of a wired link can be an Ethernet cable or a USB cable. The derived subset of information at the PACCS server can be based on a relevancy measure determined based on the known/expected characteristics and needs of the users associated with the PACCS client devices, and/or based on past history of the type of information consumed by such users. A predictive analysis, adaptive learning and collaborative filtering engine in the PACCS server proactively determines the subset of information to be derived based on characteristics, needs, and past history information. The derived subset of information is dynamically and adaptively refined as time progresses, as the available information in the Internet Cloud changes, and as the users change, or their characteristics and needs change, and as the past history of consumed information changes.

PACCS servers can maintain the type of each of connected PACCS client device, for example Smartphone, Tablet PC etc. This way, the PACCS server can serve the right amount of information based on the PAACS client device type. This is especially useful for serving images (Video/Picture) of the right resolution to the PACCS client device.

PACCS servers can optionally communicate with each other directly. This can be used for efficient exchange of relevant information without accessing the Internet Cloud.

A predictive analytics server in the internet cloud can learn content to be prepositioned at one or more access points based on the information associated with accessed content and mobility patterns associated with users of client devices that associate with the one or more access points. This facilitates distributed machine learning across the information gathered across one or more access points and one or more users.

A resident application on the PACCS client device assists in discovery of PACCS services and also assists in presentation of the available information to the user of the PACCS client device. The client device can choose whether/when to connect/fetch content from a PACCS server at an access point, based on various considerations such as wireless link conditions, network load associated with the access point, server processing load associated with the PACCS server, the cost of access or time of access, or the nature of advertised content by the server. The presentation of information to the user can be further refined based on additional constraints/properties associated with the user that are present on the PACCS client device. Based on the mobility patterns associated with the user of a PACCS client device (based on time-varying location information of the user), a PACCS server serving a user can inform one of more future expected alternate PACCS servers in advance of the possibility of the client device connecting with alternative PACCS servers. This enables the alternate PACCS servers to proactively adapt their available information to serve the user, in anticipation of a future connectivity with the PACCS client device.

If the data requested by the PACCS client device is not present in the PACCS server, optionally, the PACCS server can request the data immediately from one or more content delivery servers in the Internet Cloud.

A PACCS Management server maintains the information about all the PACCS servers and optionally about the PACCS clients which are connected to the PACCS servers. This information comprises of 1) Services configured in the PACCS server and services offered based on the connected PACCS client needs 2) Live Monitoring of the services offered by the PACCS server. This information is used to build a robust distributed system which can handle the failure of PACCS servers and optimally handle the PACCS client load.

### Configuration

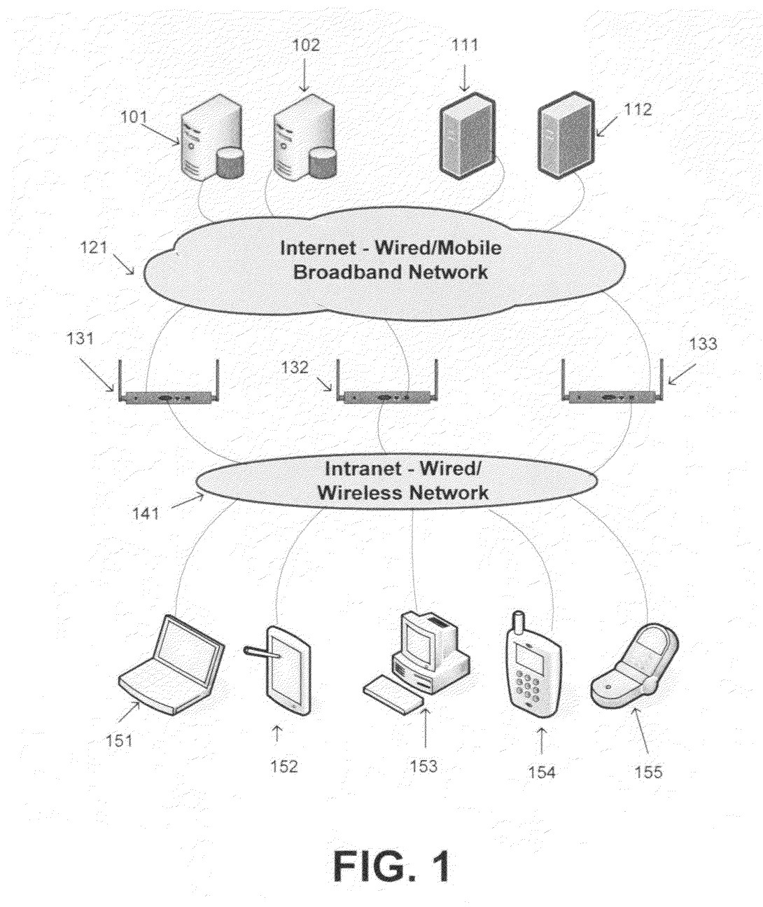

FIG. 1 is a diagram representing broadband network 121 with access to the internet in which one or more access points 131-133 are accessed by client devices 151-155 using one or more local access wired/wireless networks 141. Broadband network 121 provides access to content delivery and management servers 101-102 and predictive analytics servers 111-112. The access network 141 can be based on wireless LAN or 2G/2.5G/3G/4G cellular broadband connections. Access points 131-133 can be wireless LAN access points or base-stations or NodeBs or EvolvedNodeBs in cellular broadband access networks. Access points 131-133 provide collapsed cloud services associated with content stored in local storage associated with the access points. Client devices 151-155 can be tablets, low-end or mid-end phones, high-end phones or smartphones, laptops, desktops. A client device can be pre-provisioned with access credentials associated with the access points to enable seamless access to the access points as the device moves.

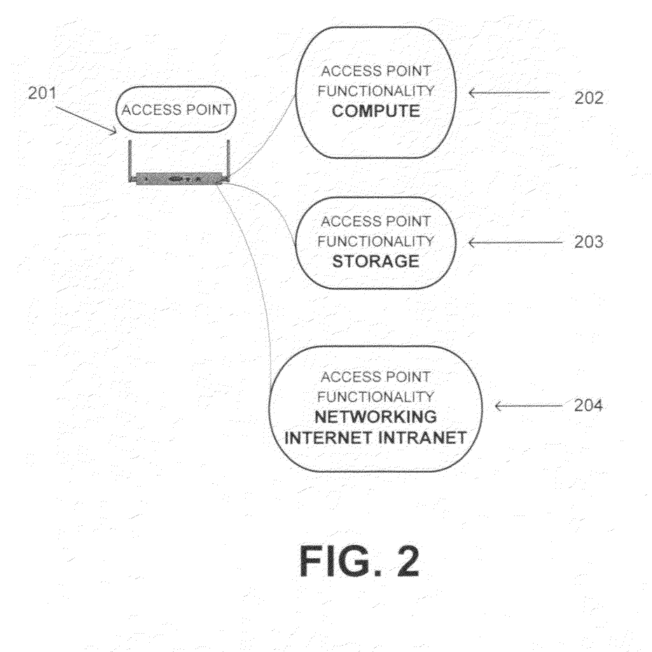

FIG. 2 is a diagram showing the configuration of an example access point or base-station or NodeB or ENodeB, with local storage, computing, and networking components. These components enable the access point to provide a local collapsed cloud service to client devices that associate with the access point. Relevant content for users can be stored in the local storage associated with the access point. The access points can directly communicate with each other using network connectivity, and can also communicate with content delivery/management servers and predictive analytics machine learnings servers in the backend. The access points can have computing capabilities such as to perform local machine learning and prediction associated with users connecting to an access point. Since machine learning can be performed in the backend, or using computing power associated with access points, such a system results in a distributed machine learning environment. Machine learning can be performed based using techniques such as clustering, regression, neural networks, support-vector-machines, markov-chain modeling, or other tools to learn the relevant content for a user based on past content accessed, and to learn and predict the access and mobility patterns of a user as a function of time. Additionally, collaborative filtering techniques can be used to perform distributed machine learning across users at the access points and/or at backend predictive analytics servers.

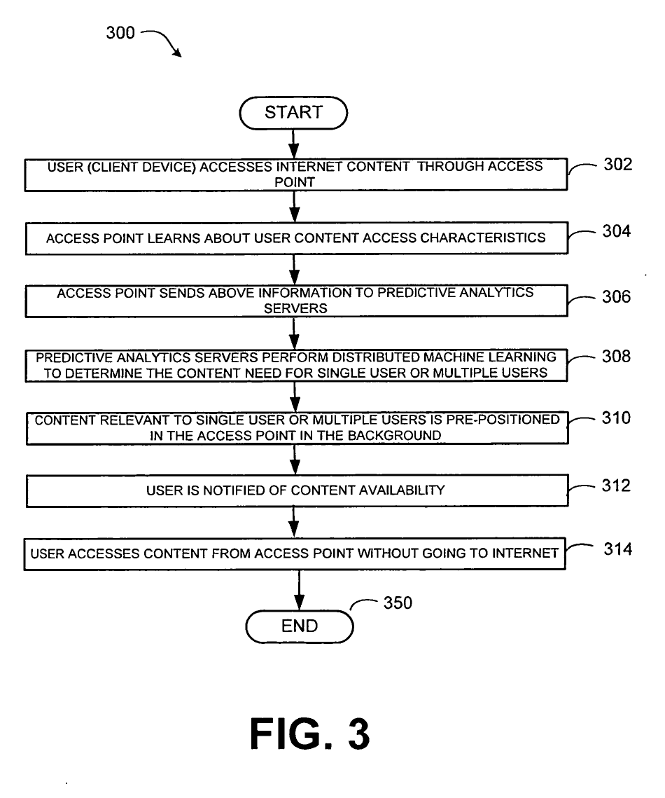

FIG. 3 is a flow diagram showing the operation of a method 300 used to provide access to content. The process starts in step 302 where a user's client device access content on the internet through an access point. The access point learns the user content access characteristics in step 304 and also sends such information to a backend predictive analytics server in step 306. The predictive analytics servers can perform distributed machine learning in step 308 across information provided by the access points used by the client device. Further distributed machine learning can be performed across multiple users accessing similar content through these access points. An access point can also proactively determine the content that needs to be prepositioned at the access point based on its own learning of a user's needs or its own learning of accesses across users. Based on the distributed learning, relevant content for a user or across users can be pre-positioned in step 310 at an access point for a user in the background prior to the user requesting access to the content. The user's client device is notified of the availability of the content at the access point in step 312. In step 314 the client device directly accesses the content from the access point using the local storage on the access point without needing to reach out to content delivery servers in the internet.

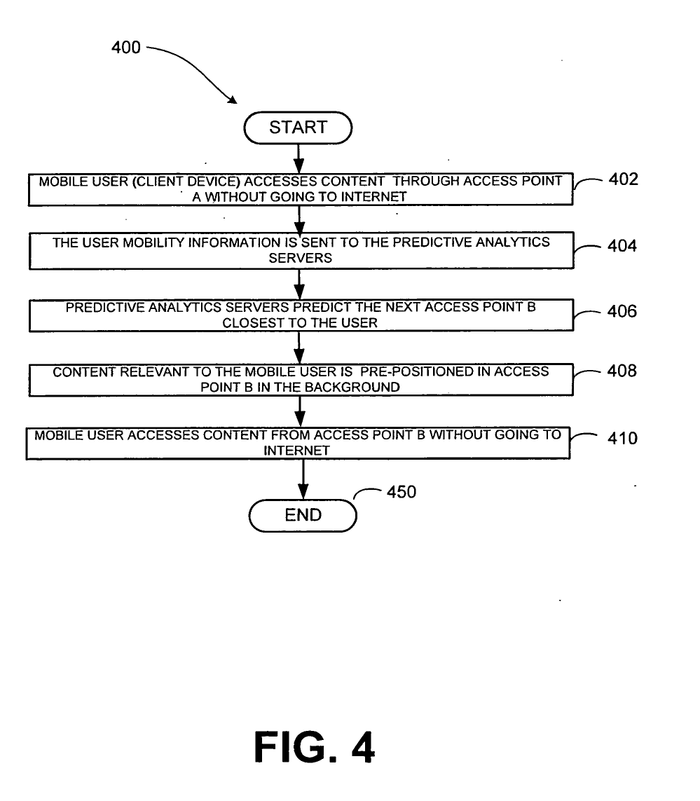

FIG. 4 is a flow diagram showing the operation of a method 400 used to provide access to content as a user moves from one access point A to another access point B. The two access points can be different wireless LAN access points for example in a enterprise network, or at an airport or train station, or in a neighborhood near the user's home, or in a shopping mall frequented by a user. Alternatively, the access points can be base-stations in a cellular broadband 2G/2.5G/3G/4G network or a combination of WLAN access points, or cellular base-stations. The process starts in step 402 where a user's client device access content on the internet through an access point A without going to the internet by accessing the content from the local storage associated with access point A. As the user moves, its mobility information such as a current location based on GPS or a triangulated location is sent in step 404 to backend predictive analytics servers, where the next access point B for the user is determined in step 406. Subsequently the content relevant to a user is prepositioned in access point B in the background in step 408. As the user's client device switches from access point A to access point B for access, the client device starts accessing the rest of the content from access point B from the local storage associated with access point B.

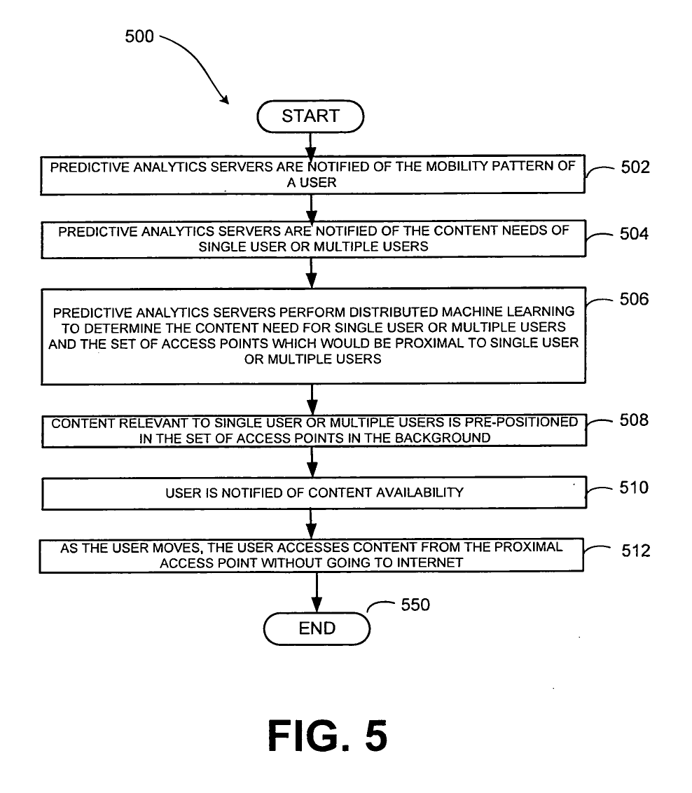

FIG. 5 is a flow diagram showing the operation of a method 500 used to predictively determine the relevant access points for a user. The process starts in step 502 where a predictive analytics server receives information of the mobility pattern of one or more users. Based on the content accessed by one or more users as received by the predictive analytics server(s) in step 504, distributed machine learning is performed in step 506 across mobility patterns of users, and across access points utilized by users, to determine the content to be prepositioned at each of the access points. In step 508, content relevant to a single user or multiple users is prepositioned in one or more access points related to the users. In step 510, the user's client device is notified of the content availability at these one or more access points that are proximal to the user. In step 512, the user accesses content from these one or more proximal access points, where the content access can be static through a single access point, or can be dynamic across the set of access points serving the user, as the user moves.

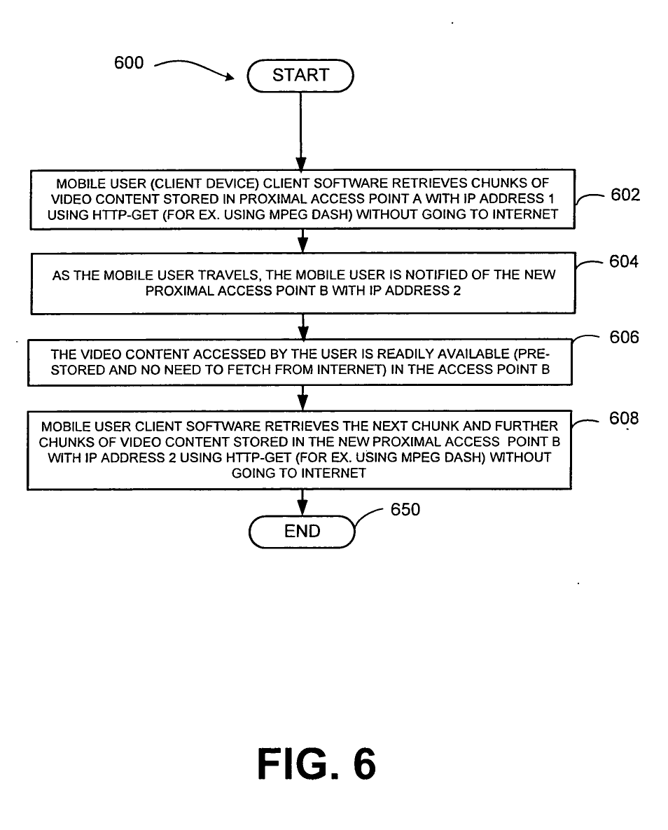

FIG. 6 is a flow diagram showing the operation of a method 600 used to access different parts of content associated with a user from different access points. The process starts with step 602 where a proximal access point A serves the user's client device where the client device uses a destination IP address IP1 to perform http-get requests to obtain segments of data associated with the content using a technology such as MPEG-DASH (Motion Picture Experts Group—Dynamic Adaptive Streaming over HTTP). As the access point A processes IP packets for routing from the client device, the destination IP address IP1 in the headers of the IP packets originating from the client device is processed, and the IP1 address is determined by access point A to terminate locally in the local storage at the access point A. This facilitates the access of the content from the local storage associated with access point A. While the segments are accessed from access point A with buffering on the client device, a new access point B is determined for serving the user, and the user's client device is provided with a new destination IP address IP2 to use when communicating via access point B. Subsequently, the HTTP GET requests with destination address IP2 are processed by access point B to be terminating at the local storage associated with access point B, thereby facilitating the access of the remaining portion of the content (such as an MPEG-DASH based video stream) from the local storage associated with access point B. It is possible that during this handoff, some incomplete HTTP-GET requests submitted to access point A, are resubmitted to access point B, so that some redundancy or overlap related to content storage is desirable across the access points. The overlap can be dynamically determined with the knowledge of the last known segment successfully received by the client device from access point A prior to the handoff from one access point to another.

### CONCLUSION

The previous description of the disclosed embodiments is provided to enable any person skilled in the art to make or use the features, functions, operations, and embodiments disclosed herein.

1. Method for a first collapsed cloud service by an access point to obtain content from the Internet Cloud to create a local collapsed cloud, for the access point to further advertise the availability of the content over one or more local networks that it supports, and where the access point determines the content to obtain or present based on known past accesses or current accesses or expected future accesses to the server.

2. Method of claim 1 where the accesses are related to accesses by one or more client devices associated with one or more users

3. Method of claim 1 where the access point restricts access to a client device to only its local collapsed cloud and does not provide Internet Cloud access

4. Method of claim 1 where the access point restricts access to a client device to only its local collapsed cloud for certain type of content only

5. Method of claim 1 where one of the one or more local networks is a wireless network

6. Method of claim 1 where the access point advertises one or more services over the said one or more local networks with respect to the content obtained

7. Method of claim 6 where the one or more services is advertised in a wireless beacon, a p2p discovery protocol, a p2p application, or custom application software

8. Method of claim 1 where the determination is performed using a predictive analysis, based on adaptive learning and collaborative filtering engine in the server to determine a relevancy measure of content for a given user

9. Method of claim 8 where the learning is based on the known/expected characteristics and needs of the users associated with the client devices that associate with access point, and/or based on past history of the type of information consumed by such users

10. Method for an internet cloud predictive analytics server to determine content to preposition at one or more access points based on distributed machine learning associated with user content accessed through the one or more access points for one or more users, and mobility patterns associated with one or more users

11. Method of claim 10 where a mobility pattern for a user constitutes information regarding time dependency of connectivity of a user through one or more access points

12. Method of claim 10 where the distributed machine learning is performed using machine learning with regard to user content access and connectivity knowledge at each of the access points, and an aggregate machine learning at the internet cloud predictive analytics server across information learned based on one or more users and learned from one or more access points

13. Method of claim 10 where machine learning is performed using but not limited to one or more of clustering, regression, neural networks, support vector machines, statistical techniques.

14. Method of claim 10 where the determined content is prepositioned at the local storage associated with one or more access points by an internet cloud content delivery server

15. Method of claim 14 where an access point further determines content to preposition or overrides suggested content to preposition by the predictive analytics server based on machine learning performed locally at the access point

16. Method of claims 1 and 12 where the learning is dynamically and adaptively refined as time progresses, as the available information in the Internet Cloud changes, and as the users change, or their characteristics and needs change, and as the past history of consumed information changes.

17. Method of claim 10 for an internet cloud content delivery server to communicate with a first access point and a second access point associated with a client device, to prepare the second access point with prepositioned content for the client device, in anticipation of a potential communication with the client device, based on a knowledge of the mobility information associated with the client device

18. Method of claims 1 and 10 and 14, where, if the data requested by the client device is not present in the collapsed cloud associated with an access point, then the access point can request the data immediately from an internet cloud content delivery server

19. Method for a client device to utilize an access point based on the network load or server load associated with the access point, or said server proximity or the quality of the wireless link between the client and the server if a wireless link is used for connectivity, the cost of access, or the nature of the available content advertised by the access point

20. Apparatus for an access point with a compute, storage, and networking components, where the apparatus provides a collapsed cloud service to client devices that connect to it, where content is prepositioned in the storage component based on machine learning associated with content access and mobility patterns associated with one or more client devices, that communicate via the access point or other access points to a content delivery server and a predictive analytics server
